(19) United States
(12) Patent Application Publication
(10) Pub. No.: US 2013/0078601 A1
(43) Pub. Date: Mar. 28, 2013

(54) Diabetic Patients Compliance and Outcomes by Publicizing that Increased Compliance Improves Blood Glucose Control and Outcomes

(71) Applicant: Kimon J. Angelides, Houston, TX (US)

(72) Inventor: Kimon J. Angelides, Houston, TX (US)

(21) Appl. No.: 13/705,341

(22) Filed: Dec. 5, 2012

Related U.S. Application Data
(63) Continuation-in-part of application No. 13/485,849, filed on May 31, 2012.
Application No. 13/485,849 is a continuation-in-part of application No. 12/693,849, filed on Jan. 26, 2010.
Application No. 12/693,849 is a continuation-in-part of application No. 13/656,692, filed on Oct. 20, 2012.

(51) Int. Cl. G09B 19/00

(52) U.S. Cl. CPC G09B 19/0092
USPC 434/236

(57) ABSTRACT

Improved outcomes of patients resulting from: continuous monitoring of blood glucose level, other metabolites, food consumption, and preferably, exertion level; and resulting from providing personalized education and other advice on insulin and drug administration, food consumption and timing, and exercise type and intensity—are publicized to increase patient compliance with the recommended diet, exercise, and/or testing, drug administration, and improve patient clinical outcomes; or are publicized to recruit new patients into the system, and thereby improve the outcomes and overall health of an increasing proportion of the diabetic patient population. The improved blood glucose level control or other measurable parameters that follow from increased patient compliance can also be publicized to improve patient compliance or recruit more patient into the system.

### RELATED APPLICATIONS

This application is a CIP of and claims priority to U.S. application Ser. No. 13/656,692, filed Oct. 20, 2012, which is a CIP of claims priority to U.S. application Ser. No. 13/485,849, filed May 31, 2012, which is a CIP of claims priority to U.S. application Ser. No. 12/693,849, filed Jan. 26, 2010, which is a nonprovisional of and claims priority to U.S. Provisional No. 61/147157, filed Jan. 26, 2009. All these applications are incorporated by reference.

### BACKGROUND

As America's fifth-deadliest disease, and as there are over 20 million American diabetics, diabetes mellitus places a particularly high expense burden on the public healthcare system. Millions of Americans are not even aware that they have the disease, and an additional 50 million plus Americans have pre-diabetes. If the present trends continues, 1 in 3 Americans, including as many as 1 in 2 minorities born in 2000 will develop diabetes during their lifetime.

Diabetes is a group of chronic metabolic diseases marked by high levels of blood glucose resulting from defects in insulin production, insulin action, or both. While diabetes can lead to serious complications and premature death, effective treatment requires the diabetic patient to take steps to control the disease and lower the risk of complications.

About 5-10% of diabetics have Type 1 diabetes, while 90-95% have Type 2 diabetes. Type 1 is an autoimmune disease while Type 2 results from insulin resistance or inadequate insulin production. Type 1 has clear genetic markers while Type 2 is genetically heterogenous and therefore has a broader and less certain origin. About 80% of Type 2 diabetics are overweight.

Since 1987, the death rate due to diabetes has increased by 45 percent, while the death rates due to heart disease, stroke, and cancer have declined, emphasizing both the failures of the current treatment approaches as well as the rapid growth of this disease.

Uncontrolled diabetes leads^{.} to chronic end-stage organ disease and in the United States is a leading cause of end-stage renal disease, blindness, non-traumatic amputation, and cardiovascular disease. It is also associated with complications such as:
Heart Disease and Stroke (#1 cause of death for diabetics and 2-4 time higher than the general population)
High Blood Pressure (3 in 4 diabetics)
Nervous System Damage (can lead to amputations and carpel tunnel syndrome)
Pregnancy Complications (including gestational diabetes)
Sexual Dysfunction (double the incidence of erectile dysfunction)
Periodontal Disease

In the USA, over 85% of people aged 65 and over have diabetes, a fact that complicates their total health picture and often accelerates chronic end-stage disease, adding an enormous strain to the healthcare system. Prevalence is highest among minorities and increases in all groups with age and obesity. In addition, there are correlations of higher diabetes incidence with smokers, and Alzheimer's patients.

Poor control of blood-glucose in diabetes dramatically increases the risk of heart disease, stroke, amputations, blindness, renal disease and failure, impotence, and many other diseases—better control of blood-glucose levels greatly mitigates these complications. Coupled with proper education, nutrition, maintenance of stable blood-glucose levels, and regular exercise, many Type 1 and 2 diabetics can minimize the effects of the disease.

With the growing problem of diabetes in developed and developing countries comes a growing need for convenient blood glucose monitoring, and convenient methods for analysis and treatment based on the monitoring. Diabetes patients need to monitor their blood glucose multiple times a day and record this information, which is analyzed, along with other parameters such as quantity of exercise and their diet, and then use the results to determine food intake, adjust the dosage of insulin and/or other therapeutic agent, and to recommended exercise intensity or cessation. Compliance with the monitoring, diet and exercise regimes is a challenge due to their complexity and temptation to avoid the recommended diet, which is low in simple sugars, and the recommended exercise regime.

U.S. application Ser. No. 13/656,692 describes a personalized system of education, monitoring and advising on glucose testing, diet, exercise and drug administration, which is based on patient preferences and data continuously input by the patient. The patient preferences, particularly for food, meal timing and exercise are input initially and then frequently updated. Educational messages are provided to the patients in the program based on blood glucose level, levels of other metabolites, time and content of last meal, exertion level, and other factors.

Initial results and patient responses indicate that the personalized system described in U.S. application Ser. No. 13/656,692, or similar personalized systems of monitoring, education and providing personalized feed-back, are effective in increasing compliance, Publicizing the increased compliance from such personalized systems allows recruiting of more patients into the system, to thereby improve clinical outcomes for an increasing patient population.

### SUMMARY

In the invention, the improved outcomes of patients resulting from: continuous monitoring of blood glucose level, of other metabolites, of food consumption, and preferably, of exertion level; and from providing personalized education and other advice on insulin and drug administration, food consumption and timing, and exercise type and intensity—are publicized to increase patient compliance with the recommended diet, exercise, and/or testing, drug administration, and improve patient clinical outcomes; or are publicized to recruit new patients into the system, and thereby improve the outcomes and overall health of an increasing proportion of the diabetic patient population. The improved blood glucose level control or other measurable parameters that follow from increased patient compliance can also be publicized to improve patient compliance or recruit more patient into the system. The steps in the process of the invention can be depicted in summary form as follows:

A PERSONALIZED SYSTEM including continuous monitoring, and providing personalized education relating to health risks associated with information received and patient preferences; as well as providing specific queries and recommendations relating to insulin and drug administration, food consumption and timing, and exercise type and intensity, where patient interactions with the SYSTEM are through the web, a wireless or GPRS link, in person, or through a cell phone, phone, or computer, and where the following steps are carried out:

PATIENT INPUT of preferences for food type and consumption schedule and food allergies; exercise type, intensity and schedule; limitations on physical ability or certain exercise types;

MONITOR patient for relevant blood glucose and other metabolite levels (CLINICAL PARAMETERS), and for feelings relating to diabetic risks (particularly related to blood glucose level) and other symptoms, and food consumed and exercise level (REPORTED PARAMETERS);

TESTING for CLINICAL PARAMETERS by analyzing a blood sample;

ENTER and UPDATE for each patient: CLINICAL PARAMETERS and REPORTED PARAMETERS, including health care worker notes and patient preferences, on Charts;

STORE Charts such that only specified access is allowed;

PERFORM statistical analysis of CLINICAL PARAMETERS and CLINICAL OUTCOMES to determine, preferably to a specified statistical significance, whether the PERSONALIZED SYSTEM is effective in providing improved CLINICAL OUTCOMES and improving control of CLINICAL PARAMETERS;

DISCLOSE the improved CLINICAL PARAMETERS and CLINICAL OUTCOMES (preferably, those which reach statistical significance for an individual in the SYSTEM or for a population in the SYSTEM) to increase compliance of patients in the SYSTEM with the testing, reporting, diet and exercise regimen; and/or

PUBLICIZE the improved CLINICAL PARAMETERS and better controlled CLINICAL OUTCOMES (preferably, those which reach statistical significance) to recruit new subjects for the SYSTEM; and

INTEGRATE the new subjects into the SYSTEM to improve their and CLINICAL OUTCOMES or improve control of their CLINICAL PARAMETERS.

Further details and exemplification of the SYSTEM is set forth below.

### DETAILED DESCRIPTION

It is well-known that control of diabetes is dependent on controlling CLINICAL PARAMETERS (blood glucose level primarily, and other metabolites, including ketones, LDL and cholesterol, secondarily). CLINICAL OUTCOMES, including survival, cardiovascular disease, cataracts, non-healing wounds, tissue necrosis and amputation are improved where there is better control of CLINICAL PARAMETERS. The control of CLINICAL PARAMETERS is related to the interaction between diet, exercise and administration of insulin and other drugs, which all need to be controlled. The control of CLINICAL PARAMETERS requires continuous monitoring of CLINICAL PARAMETERS. It is difficult for patients to determine the proper balance of diet, exercise and insulin/drug administration to best control blood glucose level, and then follow the same regimen over the course of days and weeks. Moreover, the temptation to avoid recommended exercise or seek foods that are higher in simple sugars or otherwise contra-indicated can be overwhelming without proper support.

A solution to these issues is the systems set forth in the priority applications (Ser. Nos. 13/656,692; 13/485,849; 12/693,849) where patient preferences, particularly for diet and exercise, are input and then continuously updated, and suggestions for similar foods, and similar exercise regimens, or ceasing exercise, are made. In these systems, the patient's blood glucose level and other monitored information is sent to a server for centralized monitoring and recording. Preferably, the levels and the information are sent over a wireless link, e.g., the cellular GPRS-communication linked glucometer-pedometer, described in U.S. Pat. No. 8,066,640 (incorporated by reference), and are preferably also recorded on the portable glucometer device carried by the patient.

Ser. No. 13/656,692 discusses sub-icons displayed upon actuating the “Trends” icon on the patient's device, where this icon indicates, on a constantly updated basis, the results of blood glucose and other metabolites over time, number of times blood glucose or other metabolites fall below a threshold or otherwise outside a particular range, results before and after meals, patterns over time periods, and other analysis useful to the patient and the health care team.

In the preferred SYSTEM, the patient would initially enter a number of food and exercise preferences and limitations (like allergies or physical limitations, if applicable) at the. Depending on the blood glucose level, ketone (and other metabolite) levels, exertion level, time and content of last meal, patient feelings, and last insulin administration, the patient is provided recommendations for food consumption, continuation or cessation of exercise, insulin administration; and the patient can also be provided emergency notifications like “stop driving” or “eat immediately,” or “stop exercising.” The patient is also provided educational messages related to the monitored information received and the recorded preferences, relating to, for example, the particular health risks associated with high blood glucose levels. These messages and the ability of the system to account for patient preferences and limitations in making recommendations, help to motivate the patient to adhere to the diet, exercise and testing regime, and thereby improve CLINICAL OUTCOMES for patients in the SYSTEM.

To help improve control of CLINICAL PARAMETERS and CLINICAL OUTCOMES for a broader patient population, the improved control of CLINICAL PARAMETERS and the improved CLINICAL OUTCOMES from patients already in the SYSTEM can be publicized so that a wider population of diabetics is made aware of the improved CLINICAL OUTCOMES related to the SYSTEM. The improvements in control of CLINICAL PARAMETERS and improvements in CLINICAL OUTCOMES which are reported are preferably those which can be shown with statistical significance.

As more patients enter the SYSTEM, their results are also entered, tracked and analyzed. The data analysis can be segmented further as the patient population increases. The segmenting can include analysis of correlations between the variance of individual or groups of CLINICAL PARAMETERS and the effect on CLINICAL OUTCOMES. For example, one can correlate the frequency with which blood glucose exceeds a specified level with the incidence of particular adverse CLINICAL OUTCOMES (preferably, with statistical significance).

Also, as the data available for each patient in the SYSTEM increases, correlations between the variance in CLINICAL PARAMETERS and the effect on CLINICAL OUTCOMES can be individualized. For example, the correlations between frequency of incidence of high blood glucose level and slow wound healing can be correlated for individuals in the SYSTEM. Again, the correlations are preferably analyzed to statistical significance (p value ≦0.05). In this way, individuals can be aware of their propensities for adverse CLINICAL OUTCOMES, and whether the frequency of monitoring of CLINICAL PARAMETERS should be increased, or whether diet, exercise, insulin or other drug administration should be modified or more frequently monitored.

The data tracking for each patient could also compare incidence of CLINICAL OUTCOMES which occurred over a particular period where there was less strict compliance with the recommended diet, exercise or testing regimen, with those where there was more strict compliance. The comparison could be, for example, of the CLINICAL OUTCOMES before the patient entered the SYSTEM as against incidence of the same CLINICAL OUTCOMES after the patient entered the SYSTEM, or of CLINICAL OUTCOMES during a period when CLINICAL PARAMETERS varied widely from recommended levels, to a period where the CLINICAL PARAMETERS remained more in range. One such CLINICAL OUTCOME which may be readily tracked is frequency of slow healing wounds, especially if there are records of physician visits to treat such wounds from before the patient entered the SYSTEM. These records can be compared to clinical records showing frequency of wound healing after the patient entered the SYSTEM. Again, the results can be statistically analyzed to determine the statistical significance (p value) of the correlation between the patient using the SYSTEM and decreased incidence of slow-healing wounds. In this analysis, slow-healing wounds can be defined as those which fail to heal within a specified time.

While it is preferable that CLINICAL PARAMETERS are automatically reported and recorded (see U.S. application Ser. No. 13/656,692) following patient testing, the patients in the SYSTEM are also preferably sent frequent inquiries requiring their response and reporting, including information about food consumption, exercise and their feelings and symptoms which indicate CLINICAL PARAMETERS may be out of the desired range. A further level of analysis is to determine the correlation between patient reporting compliance and CLINICAL OUTCOMES; i.e., determine whether subjects with significant lapses in reporting frequency suffer increased incidents of adverse CLINICAL OUTCOMES. Again, if it is demonstrated with statistical significance that increased reporting compliance improves CLINICAL OUTCOMES, this correlation could be publicized to increase reporting compliance of patients in the SYSTEM, and to draw more patients into the SYSTEM.

A further level of analysis which can be done as the patient population in the SYSTEM increases is to determine the likelihood of effect on CLINICAL OUTCOMES from particular events; e.g., blood glucose out of range, or past a threshold which indicates it is significantly out of range; ketone level out of range, or past a threshold indicating it is significantly out of range; contra-indicated foods consumed, high patient obesity level, failure to perform recommended exercise for a particular period, or exceeding recommended exertion level for a particular period. The likelihood can be determined using the Cox proportional hazards model where these events are explanatory covariates and the baseline covariates include patient age, weight, and others,

With the same analysis (Cox proportional hazards model) one can also determine the likelihood of effect on CLINICAL PARAMETERS, particularly, blood glucose level or ketone level, from diet and exercise events. For example, one can determine the likelihood that eating a quantity of candy will move blood glucose past a threshold.

The determination of likelihood of effect on CLINICAL OUTCOMES from particular events or on CLINICAL PARAMETERS from diet or exercise events, is described above as based on the patients in the SYSTEM and therefore applying to the entire SYSTEM patient population. But, as data about an individual in the SYSTEM accumulates, the likelihood of effect on his/her CLINICAL PARAMETERS from diet or exercise events can be determined on an individual basis. That is, the individual can be provided the likelihood that eating a particular quantity of candy will move his/her blood glucose past a threshold, based on analysis of that individuals' records.

The likelihood of the effect on CLINICAL OUTCOMES from particular events or the effect on CLINICAL OUTCOMES or CLINICAL PARAMETERS from diet or exercise events, or from overall increased or decreased compliance with the recommended diet and exercise regime, is intended for use in patient education to improve their CLINICAL OUTCOMES through increasing compliance. With the real-time patient/server interaction with the SYSTEM, the patient can be provided educational messages about the level of risk from particular events or from diet or exercise events. For example, if patient blood glucose or ketone level tests at above a threshold, the patient can be advised (from the server, preferably) of the likelihood of particular CLINICAL OUTCOMES for the patient population. Similarly, the patient can be advised of the individualized risk that his blood glucose will surpass a desirable level if he eats a quantity of candy (preferably in response to a patient query on that question). Again, the capability in the SYSTEM to provide likelihood of effect on CLINICAL OUTCOMES from particular events or on CLINICAL PARAMETERS from diet or exercise events can be publicized as a tool to recruit additional patients into the SYSTEM, and thereby expand the pool of patients having increased compliance to their treatment regimes.

In addition to analyzing CLINICAL PARAMETERS and diet and exercise events for correlation with CLINICAL OUTCOMES, it is also possible to correlate the capability the SYSTEM provides for more frequent monitoring and interactive advice and educational messages with patient compliance with the testing, drug administration, diet and exercise regime. That is, as a patient enters the SYSTEM his/her compliance can be monitored and analyzed to indicate what the compliance typically was prior to entering the SYSTEM, or what it is over a particular period after entering the SYSTEM, and also whether using the SYSTEM over time increases compliance. It can be determined if compliance with different aspects of the treatment regimen increases, decreases or remains stable as the patient interacts with the SYSTEM. The compliance determination can also be expanded to determine if the entire SYSTEM population experiences increased compliance as time in the system increases. Again, assuming compliance increases, the increased compliance can be publicized as a tool to recruit additional patients into the SYSTEM, and thereby expand the pool of patients with increased compliance to their treatment regimes.

It is further noted that methods other than the Cox proportional hazards model (including other regression analysis and including Kaplan-Meier analysis of survival) could be used to determine the likelihood of effect on CLINICAL OUTCOMES from particular events or on CLINICAL PARAMETERS from diet or exercise events. Other methods will occur to those of skill in the art and are incorporated herein.

It is noted above that the patient information in the SYSTEM is stored on Charts. This patient information includes blood glucose levels, blood chemistry, medical history and diagnoses, drug reactions, allergies, family medical history, lab reports, physicians notes and nurses notes. Charts may also include the patient preferences for food and exercise.

The Charts are preferably stored in the server, which provides interaction with the patients in the SYSTEM. As the Charts contain private medical records, access to them needs to be controlled to protect patient privacy. However, it is preferred that the patient or the patient's physician can obtain access to the Charts from remote locations, and preferably the access is by the web, or by wireless or GPRS link but can also include atmospheric transmission, as well as transmission through sub-space or space; transmission through fiber-optic cable, superconductive materials, cable, telephone lines, or other links for data transmission. Access may be expanded to other health care workers so the Charts can be updated with other patient information, or access should also be allowed to emergency physicians in the event of a patient health crisis.

The Payor for the patient's healthcare (Medicare, Medicaid, or private insurance) should also be allowed access to particular information from the Charts so that the Payor can review costs/FTE, payments, risk groups, and diabetes medical metrics in determining reimbursement for patient health care costs. But the information the Payor needs is limited to things like number of tests performed by the patient, and costs of the SYSTEM, so the other information in the Charts need to be coded/redacted to maintain its confidentiality. Certain of this information may also be available in coded or redacted form to an auditor of the accounts for Payor or another party.

As described above, after patient data is compiled and CLINICAL OUTCOMES are analyzed, summaries of results are to be publicized to recruit additional patients into the SYSTEM. The summaries publicized can include individual improvements in an individual's CLINICAL OUTCOME; improvements in an individual's maintenance of CLINICAL PARAMETERS within a range; improvements in an individual's compliance with the recommended CLINICAL PARAMETER testing, drug administration, and diet and exercise regime; and improvements in reporting compliance and CLINICAL OUTCOMES. The summaries publicized can also be of the SYSTEM population's improvements in CLINICAL OUTCOMES; improvements in the SYSTEM population's maintenance of CLINICAL PARAMETERS within a range; improvements in the SYSTEM population's compliance with the recommended CLINICAL PARAMETER testing, drug administration, and diet and exercise regime; and improvements in the SYSTEM population's reporting compliance and their CLINICAL OUTCOMES.

Publicizing of such results and information can be by one or more of: publishing articles in scientific or medical journals; filing published patent applications; sending information about the results through electronic media (telephone solicitations, television, radio, or internet advertising) or through the mail or through direct contact with consumers. Publicizing also includes posting such results and information on a website, a billboard or other location accessible to consumers and medical professionals. Any publicizing of results that discusses the advantages, improved compliance, improved CLINICAL PARAMETERS or improved CLINICAL OUTCOMES experienced through using the SYSTEM would fall within the scope of publicizing results, as would any attempt to recruit patients into the SYSTEM based on such advantages or improvements.

The CLINICAL PARAMETERS are determined using diagnostic tests, for example, conventional blood glucose level testing using test strips and an electronic reader. However, CLINICAL PARAMETERS can include a number of marker determinations, including genetic markers or protein assays, gene expression levels, or other assays for any chemical, compound, nucleic acid, protein, organism, virus, prion or biological material, and including tests where there is an interaction involving a chemical change in the form of hybridization, adsorption, binding, bonding (including covalent, non-covalent, polar and Van der Waals) chelation, or another reaction or interaction involving transformation of matter. The diagnostic tests include those for nucleic acids which rely on fluorescence detection, radiation detection, or other chemical or biological indicators of interaction or transformation of matter.

The specific methods, processes and compositions described herein are representative of preferred embodiments and are exemplary and not intended as limitations on the scope of the invention. Other objects, aspects, and embodiments will occur to those skilled in the art upon consideration of this specification, and are encompassed within the spirit of the invention as defined by the scope of the claims. It will be readily apparent to one skilled in the art that varying substitutions and modifications may be made to the invention disclosed herein without departing from the scope and spirit of the invention. The invention illustratively described herein suitably may be practiced in the absence of any element or elements, or limitation or limitations, which is not specifically disclosed herein as essential. Thus, for example, in each instance herein, in embodiments or examples of the present invention, any of the terms “comprising”, “including”, containing”, etc. are to be read expansively and without limitation. The methods and processes illustratively described herein suitably may be practiced in differing orders of steps, and that they are not necessarily restricted to the orders of steps indicated herein or in the claims. It is also noted that as used herein and in the appended claims, the singular forms “a,” “an,” and “the” include plural reference, and the plural include singular forms, unless the context clearly dictates otherwise. Under no circumstances may the patent be interpreted to be limited to the specific examples or embodiments or methods specifically disclosed herein. Under no circumstances may the patent be interpreted to be limited by any statement made by any Examiner or any other official or employee of the Patent and Trademark Office unless such statement is specifically and without qualification or reservation expressly adopted in a responsive writing by Applicants.

The invention has been described broadly and generically herein. Each of the narrower species and subgeneric groupings falling within the generic disclosure also form part of the invention.

The terms and expressions that have been employed are used as terms of description and not of limitation, and there is no intent in the use of such terms and expressions to exclude any equivalent of the features shown and described or portions thereof, but it is recognized that various modifications are possible within the scope of the invention as claimed. Thus, it will be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

What is claimed is:

1. A process of increasing diabetic patient compliance with a recommended diet and exercise regime, comprising:
Providing a recommended diet and exercise regimen for the patient to follow for a particular forthcoming period;
Providing an interactive link between a server and device(s) carried by the patient which tests for blood glucose level and which determines patient exertion level by measuring patient movement or acceleration, and where the device(s) or the server queries the patient about prior food consumption and time of food consumption, and where based on analysis of the blood glucose level test results, exertion level and query responses, the patient is sent advisory messages about future food consumption and timing of food consumption, about timing of further testing, and about continuing or ceasing exertion, if the patient is engaging in exertion at the time the advisory message is sent;
Monitoring whether patient compliance with the recommended diet and exertion regimen increases or decreases compared to a prior period, based on monitoring of the patient's responses to the queries;
Determining whether during the monitored period, one or more of the patient's clinical outcomes improves, compared to a prior period, when there is increased patient compliance with the recommended diet and exercise regimen during said monitored period, or whether one or more of the patient's clinical outcomes declines when there is decreased patient compliance with the recommended diet and exercise regimen during said monitored period; and
Disclosing that one or more of the patient's clinical outcomes improve when there is increased patient compliance with the recommended diet and exercise regimen, or disclosing that one or more of the patient's clinical outcomes declines when there is decreased patient compliance with the recommended diet and exercise regimen, in order to improve compliance of the patient or of other patients with their respective recommended diet and exercise regimens.

2. The process of claim 1 further including publicizing the improved patient clinical outcomes or the improved patient compliance with the recommended diet and exercise regimens in order to recruit more patients.

3. The process of claim 1 further including advising the patient, from the server, to cease exertion or increase exertion based on patient preferences and limitations entered in the server, and one or more of: blood glucose level, time from last food intake, time from last insulin or drug administration, and patient's reported feelings and symptoms.

4. The process of claim 1 further including advising the patient, from the server, to eat, and what to eat, based on patient preferences and limitations entered in the server, and one or more of: blood glucose level, time from last food intake, time from last insulin or drug administration, and patient's reported feelings and symptoms.

5. The process of claim 1 further including providing education to the patient, based on patient preferences and limitations entered in the server, of risks involved with disregarding the recommended diet and exercise regimen, or with blood glucose or ketone levels outside of specified ranges.

6. The process of claim 5 wherein the education provided to the patient is also based on one or more of the patient's: blood glucose level, time from last food intake, time from last insulin or drug administration, and patient's reported feelings and symptoms.

7. The process of claim 1 wherein patient preferences and limitations are entered in the server and are frequently updated by the patient.

8. The process of claim 1 wherein the patient tests for blood glucose level, ketone level, LDL and cholesterol.

9. The process of claim 1 wherein in response to queries, the patient provides information including feelings, reactions to medications, exertion level, time from last food intake, and time from last drug administration.

10. A process of increasing diabetic patient compliance with a recommended testing, diet and exercise regime, comprising:
Providing a recommended testing, diet and exercise regimen for the patient to follow for a particular forthcoming period;
Providing an interactive link between a server and device(s) carried by the patient which tests for blood glucose level and which determine patient exertion level by measuring patient movement, and where the device(s) or the server query the patient about prior food consumption and time of consumption, and where based on analysis of the blood glucose level test results, exertion level and query responses, the patient is provided advisory messages about future food consumption and timing of food consumption, about timing of further testing, and about continuing or ceasing exertion, if the patient is engaging in exertion at the time the advisory message is sent;
Monitoring whether blood glucose level remains within a recommended range for a monitored period during which the patient more strictly adheres to the testing, diet and exercise regimen recommendations, and comparing it to a period where blood glucose falls outside a recommended range for a monitored period during which the patient less strictly adheres to the testing, diet and exercise regimen recommendations; and
Disclosing that the blood glucose level remains within a recommended range when there is more strict patient compliance with the recommended testing, diet and exercise regimen, or that the blood glucose level falls outside the recommended range when there is less strict patient compliance with the recommended testing, diet and exercise regimen, in order to improve compliance of the patient or of other patients with their respective recommended testing, diet and exercise regimens.

11. The process of claim 10 further including publicizing the improved blood glucose level control associated with improved patient compliance with the recommended diet and exercise regimens in order to recruit more patients.

12. The process of claim 10 further including advising the patient, from the server, to cease exertion or increase exertion based on patient preferences and limitations entered in the server, and one or more of: blood glucose level, time from last food intake, time from last insulin or drug administration, and patient's reported feelings and symptoms.

13. The process of claim 10 further including advising the patient, from the server, to eat, and what to eat, based on patient preferences and limitations entered in the server, and one or more of: blood glucose level, time from last food intake, time from last insulin or drug administration, and patient's reported feelings and symptoms.

14. The process of claim 10 further including providing education to the patient, based on patient preferences and limitations entered in the server, of risks involved with disregarding the recommended diet and exercise regimen, or with blood glucose or ketone levels outside of specified ranges.

15. The process of claim 14 wherein the education provided to the patient is also based on one or more of the patient's: blood glucose level, time from last food intake, time from last insulin or drug administration, and patient's reported feelings and symptoms.

16. The process of claim 10 wherein patient preferences and limitations are entered in the server and are frequently updated by the patient.

17. The process of claim 10 wherein the patient tests for blood glucose level, ketone level, LDL and cholesterol.

18. The process of claim 10 wherein in response to queries, the patient provides information including feelings, reactions to medications, exertion level, time from last food intake, and time from last drug administration.

19. The process of claim 10 wherein the patient's blood glucose level, ketone level or other patient status indicator can trigger health care worker intervention and advice from the health care worker.

20. The process of claim 1 wherein the patient's blood glucose level, ketone level or other patient status indicator can trigger health care worker intervention and advice from the health care worker.
